(19) United States
(12) Patent Application Publication
(10) Pub. No.: US 2009/0260965 A1
(43) Pub. Date: Oct. 22, 2009

(54) LIGHT-EMITTING MODULE AND KEYBOARD

(75) Inventor: Chao-Lung CHANG, Taoyuan (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DARFON ELECTRONICS CORPORATION, Taoyuan (TW)

(21) Appl. No.: 12/424,152

(22) Filed: Apr. 15, 2009

(30) Foreign Application Priority Data
Apr. 22, 2008 (TW) 097114625

(51) Int. Cl. H01H 9/00; F21V 1/00

(52) U.S. Cl. 200/314; 362/235

(57) ABSTRACT

A keyboard and a light-emitting module therefore are provided. The light-emitting module includes a first light source, a first light guide element, a first reflecting element and a second light source. The first light guide element has a first cavity, and the first light source is disposed in the first cavity. The first reflecting element having at least one opening is disposed under the first light guide element. The second light source is disposed under the first reflecting element, and the light emitted from the second light source passes through the opening.

### CROSS REFERENCE TO RELATED APPLICATIONS

This application claims the right of priority based on Taiwan Patent Application No. 97114625 entitled “Light-emitting module and keyboard” filed on Apr. 22, 2008, which is incorporated herein by reference and assigned to the assignee herein.

### FIELD OF THE INVENTION

This invention relates to a light-emitting module, and more particularly relates to a light-emitting module capable of locally emitting light in different colors and a keyboard therewith.

### BACKGROUND OF THE INVENTION

Consumer electronics, e.g. computer, electronic dictionary and mobile phone, have been becoming more and more popular in recent decades, and most of them are equipped with a keyboard. However, users usually cannot conveniently operate them in a dark environment or a place where no sufficient light is available.

To continuously operate the keyboard or do the keystrokes, a conventional method employs a electroluminance plate as a light source that is disposed inside the keyboard. The electroluminance plate emits light when the power is supplied thereto, such that the keyboard is luminous. However, such the electroluminance emits only a single color light, leading to that the light-emitting keyboard presents only one color. As a result, the users distinguish all of the keys in the keyboard depending on the luminous intensity of the keys. In another conventional method, a light source, e.g. light-emitting diode or organic light-emitting diode, is disposed under each key. However, it increases the costs and renders a heat dissipation issue for the keyboard.

Accordingly, an improved keyboard capable of being operated in the dark environment is desirable.

### SUMMARY OF THE INVENTION

One aspect of the invention provides a light-emitting module that facilitates assembly and contributes in reduction of fabrication costs. Specifically, the light-emitting module is capable of locally emitting light in different colors.

One embodiment of the invention provides a light-emitting module. The light-emitting module includes a first light source, a first light guide element, a first reflecting element and a second light source. The first light guide element has a first cavity, and the first light source is disposed in the first cavity. The first reflecting element having at least one opening is disposed under the first light guide element. The second light source is disposed under the first reflecting element, and the light emitted from the second light source passes through the opening.

In another embodiment, the light-emitting module further includes a second light guide element having a second cavity in which the second light source is disposed. In still another embodiment, a light-shielding element above the first light guide element, and the light-shielding element has a predetermined pattern for reduction of light scattering. In each of the aforementioned embodiments, the first and second light sources of the light-emitting module emit light in different colors.

Another aspect of the invention provides a keyboard possessing various regions of different colors that help users press the keys faster and more correctly.

In one embodiment of the invention, a keyboard is disclosed, comprising: a key module and a light-emitting module under the key module, The light-emitting module comprises: a first light source; a first light guide element having a first cavity in which the first light source is disposed; a first reflecting element having at least one opening, the first reflecting element being disposed under the first light guide element; and a second light source disposed under the first reflecting element, wherein light emitted from the second light source passes through the opening; wherein the first light source and the second light source emit light in different colors, resulting in that the key module possesses various regions of different colors.

In another embodiment, the light-emitting module of the keyboard further includes a light-shielding element above the first light guide element, and the light-shielding element has a predetermined pattern for reduction of light scattering. In yet another embodiment, the light-emitting module of the keyboard further includes a third light source under the first reflecting element, and the first, second and third light sources emit light in different colors. In each of the aforementioned embodiments, the first light source and the second light source are light-emitting diode and emit light in different colors.

The objects and the features of the present invention may best be understood by reference to the detailed description with the accompanying drawings.

### BRIEF DESCRIPTION OF THE DRAWINGS

FIG. 1 is a cross-sectional view illustrating a keyboard in accordance with a first embodiment of the present invention.

FIG. 2 is an exploded assembly drawing illustrating a light-emitting module in accordance with a first embodiment of the present invention.

FIG. 3 is a cross-sectional view illustrating a light-emitting keyboard in accordance with a second embodiment of the present invention.

FIG. 4 is a cross-sectional view illustrating a light-emitting keyboard in accordance with a third embodiment of the present invention.

### DETAILED DESCRIPTION OF THE INVENTION

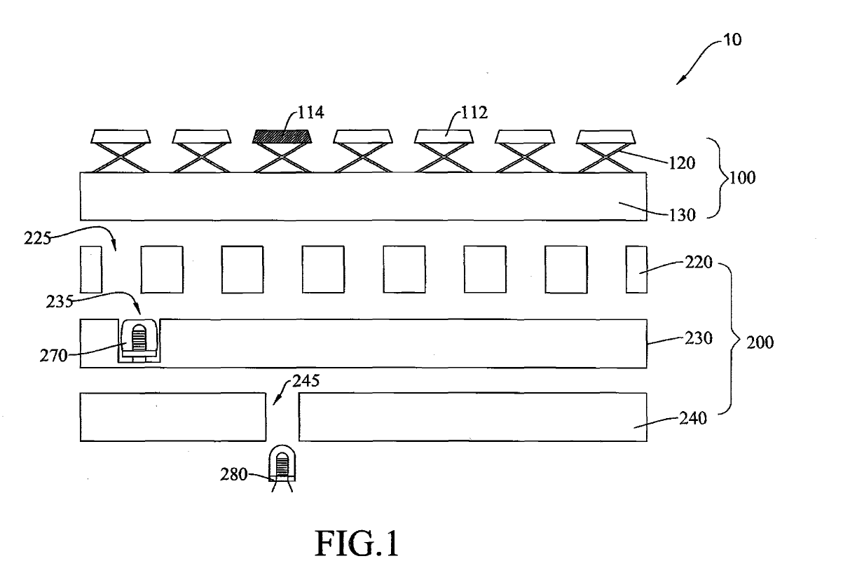

FIG. 1 is a cross-sectional view illustrating a keyboard 10 in accordance with a first embodiment of the present invention. In the first embodiment, the keyboard 10 refers to that of a laptop or a desktop computer, but is not limited thereto. The keyboard described hereinafter can be any input unit capable of receiving signals, e.g. the keyboard of a mobile phone or the keyboard of an electronic dictionary. The keyboard 10 mainly includes a key module 100 and a light-emitting module 200 there below. The key module 100 is composed of a plurality of keys 112 and 114, a support 120 and a thin circuit board 130, and shows signals that are inputted through the keys 112 and 114 by users in a screen. Alternatively, the key module 100 provides a computer with instructions for controlling programs that are executed.

As shown in FIG. 1, the light-emitting module 200 is composed of a light-shielding element 220, a first light guide element 230 having a first cavity 235, a first reflecting element 240 having at least one opening 245, a first light source 270 disposed in the first cavity 235, and a second light source 280 disposed under the opening 245. The light emitted from the second light source 280 passes through the opening 245 and arrives at a portion, such as the key 114 corresponding to the opening 245, of the key module 100. Accordingly, it leads to that the key module 100 possesses various regions of different colors, as described in detail later.

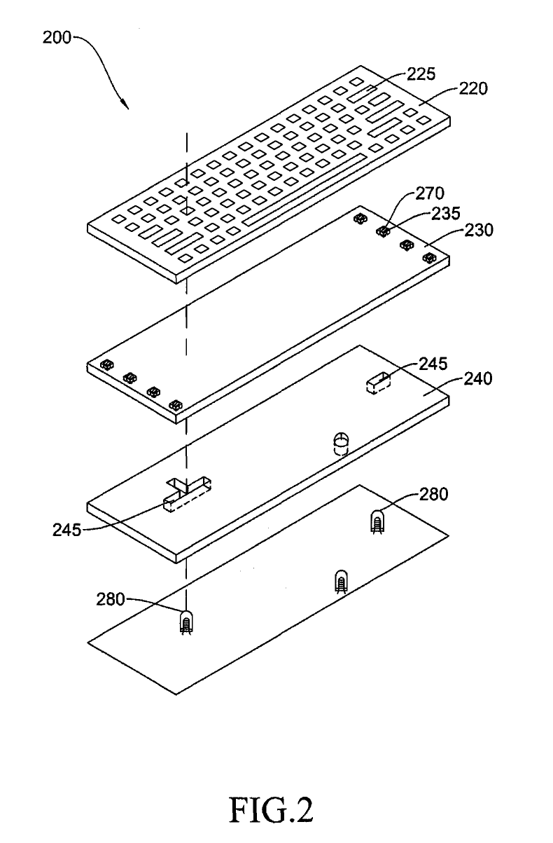

FIG. 2 is an exploded assembly drawing illustrating a light-emitting module in accordance with a first embodiment of the present invention. As shown in FIG. 2, the light-shielding element 220 can be a resin thin film including light-shielding pigments, e.g. a polyethylene terephthalate (PET) thin film having a black pigment or a polyvinyl-chloride (PVC) thin film having a black pigment. The light-shielding element 220 has a predetermined pattern, as shown in FIG. 2, for not only allowing light emitted from the first light source 270 and/or the second light source 280 passes through but also reducing light scattering. In the first embodiment, the predetermined pattern of the light-shielding element 220 has a plurality of light permeable portions 225 for directing light from the first light guide element 230 to reach predetermined keys, such as the key 112. To inhibit light scattering that takes places between adjacent keys, the light permeable portions 225 of the light-shielding element 220 is designed to a size which is a little bit smaller than that of the keys. It is noted that, in other embodiments, the shape, quantity and dimension of the light permeable portions 225 for the predetermined pattern may be modified depending on design requirements.

As shown in FIG. 1 and FIG. 2, the first light guide element 230 is disposed under the light-shielding element 220, and the first cavity 235 is disposed within a peripheral area of the first light guide element 230. In addition, the first light source 270 is disposed in the first cavity 235. In this embodiment, there are four such the first cavities 235 in each lateral portion along the longitudinal direction of the peripheral area of the first light guide element 230, however, the invention is not limited thereto. In other embodiments, a person with ordinary skill in the art may alter the quality and arrangement for the first cavity 235 with the first light source 270 therein depending on the design requirements. For example, such the first cavity 235 can be disposed within the central portion of the first light guide element 230 and/or both lateral portions along the latitudinal direction of the peripheral area of the first light guide element 230. The first light guide element 230, e.g. a light guide plate made of highly light permeable materials including polyester or poly(methyl methacrylate) serves as a medium for transmitting light, such that light emitted from the first light source 270 within the lateral portions can effectively emit from a light-emitting surface and pass through the light permeable portions 225 of the light-shielding element 220. As a result, the key module 100 possesses a first color region, e.g. the key 112.

Furthermore, the first reflecting element 240 is disposed under the first light guide element 230 for using light downward leaking from the first light guide element 230 again, such that not only light can be effectively used but also light leakage can be avoided. Materials of the first reflecting element 240 can be a conventional PET thin film having reflective coatings or an aluminum thin film. It is noted that, in one embodiment of the invention, the first reflecting element 240 has at least one opening 245 for light generated by the second light source 280 under the first reflecting element 240 to pass through. Accordingly, the key module 100 possesses a second color region, e.g. the key 114. Alternatively, the second light source 280 is under each opening 245 of the first reflecting element 240, therefore, light passing each opening 245 concentrates and reaches each corresponding key, e.g. the key 114. In this embodiment, the first reflecting element 240 has three openings of different geometrical shapes, for example, rectangular, circular, and T-shaped, as shown in FIG. 2. However, the invention is not limited thereto, and a person with ordinary skill in the art may alter the arrangement, dimension and shape of the opening 245 depending on the design requirements.

A light-emitting diode (LED) element is widely applied in various fields due to its strengths of high luminescence intensity, high luminous efficiency, low power consumption, and long service life. In addition, its structure is simple and compact to be easily incorporated into a light guide element. An LED element can be white light LED, red light LED, blue light LED, yellow light LED, green light LED, or multi-color LED. The multi-color LED is a larger LED in which a number of light-emitting diodes are disposed, e.g. an RGB LED with the red light LED, blue light LED, and green light LED therein. Because the multi-color LED has a large volume, a relatively thicker light guide element is needed when the multi-color LED serves as a light source. In one embodiment, the first light source 270 and the second light source 280 employ two LED elements emitting light of different colors, such that the key module 100 possesses various regions of different colors. For example, the first light source 270 can be white light LED, and the second light source 280 can be red light LED, thus, the key module 100 possesses a first color region, e.g. the key 112, and a second color region mixed by white light and red light, e.g. the key 114.

To computer game players, the most frequently used keys include “A” “S”, “D”, “W”, “Space”, “Enter”, and arrow keys. If these keys employ specific colors, the computer game players can accurately press the keys they want in the dark circumstance. In the keyboard 10 of the first embodiment, the first light source 270 is disposed in the first light guide element 230, such that the key 112 of the key module 100 possesses a first color region. Furthermore, the second light source 280 capable of emitting light of different colors is disposed under the opening 245 of the first reflecting element 240. Specifically, the shape and arrangement of the opening 245 correspond to those of the keys, e.g. “A”, “S”, “D”, “W”, “Space”, and “Enter”. In doing so, the key module 100 of the keyboard 10 possesses a second color region including the keys 14, e.g. “A” “S”, “W”, “Space”, and “Enter” for recognition.

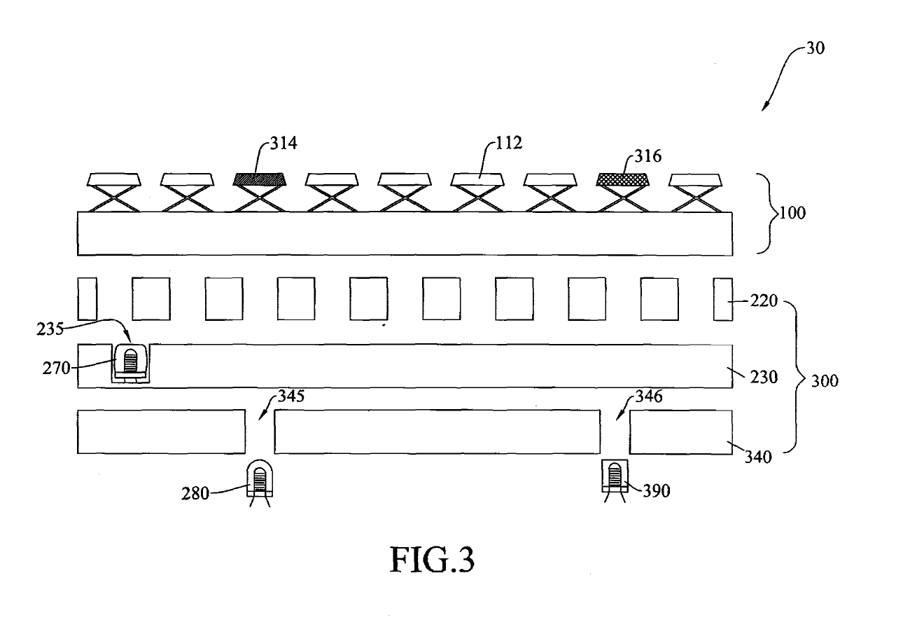

FIG. 3 is a cross-sectional view illustrating a light-emitting keyboard in accordance with a second embodiment of the present invention. As shown in FIG. 3, the second embodiment discloses a light-emitting keyboard 30 including a key module 100 and a light-emitting module 300, and the descriptions identical or similar to the first embodiment, such as the key module 100, light-shielding element 220, first light guide element 230, first light source 270, second light source 280, other related components and mutual relations there between, are omitted here. In this embodiment, the light-emitting module 300 further comprises a third light source 390 under a first reflecting element 340. The third light source 390 is an LED element, e.g. an blue light LED, emitting light different from that of the first light source 270 or second light source 280. Additionally, in this embodiment, the first reflecting element 340 has openings 345 and 34, as shown, respectively corresponding to the keys 314 and 316. As aforementioned, the keys 314 and 316 to which the openings 345 and 34 correspond can be the most frequently used keys including “A”, “S”, “D”, “W”, and “Space” by the computer game players. Alternatively, it also can be altered, if necessary, depending on any design requirements.

As shown in FIG. 3, the second light source 280 and third light source 390 of the light-emitting module 300 are respectively disposed under the openings 345 and 346 of the first reflecting element 340, and light of different colors emitted from the second light source 280 and third light source 390 respectively pass through the openings 345 and 346. Therefore, the key module 100 has not only the first color region, i.e. the key 112, but also the second color region, i.e. the key 314, and the third color region, i.e. the key 316. As aforementioned, the users can fast find and accurately press the keys they want by using a keyboard capable of locally emitting light in different colors. Although this embodiment in which three light sources emitting light of different colors provide the key module with three different color regions, it should be appreciated that a person with ordinary skill in the art may make any modifications depending on the design requirements. For example, four or more light sources emitting light of different colors are provided, for creating four or more different color regions in the key module of the keyboard.

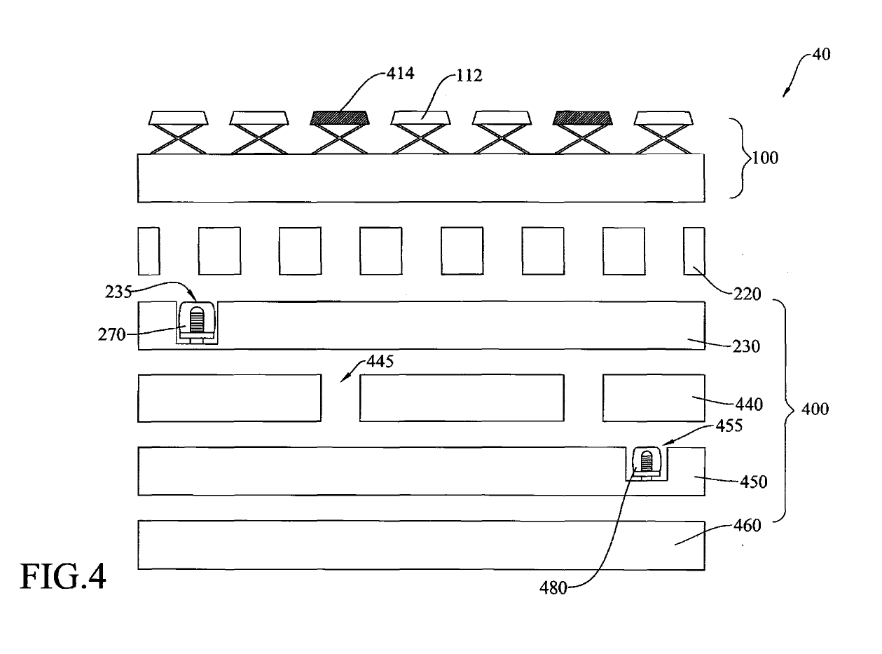

FIG. 4 is a cross-sectional view illustrating a light-emitting keyboard 40 in accordance with a third embodiment of the present invention. As shown in FIG. 4, the third embodiment discloses a light-emitting keyboard 40 including a key module 100 and a light-emitting module 400, and the descriptions identical or similar to the first embodiment are omitted here. In this embodiment, the light-emitting module 400 further comprises a second light guide element 450 having a second cavity 455 and a second reflecting element 460 under the second light guide element 450. The second light guide element 450 can employ a material, e.g. PET, identical to that of the first light guide element 230, however, the invention is not limited thereto. In other embodiments, other materials may be employed depending on occasions. Furthermore, for enhancing the light utilization efficiency, the second reflecting element 460 is disposed under the second light guide element 450. The second reflecting element 460 can reflect light emitted downwardly from the second light guide element 450, such that the light dissipation can be avoided. The second reflecting element 460 can employ a material identical to or different from that of the first reflecting element 240, e.g. a PET thin film having reflective coatings or an aluminum thin film, but the invention is not limited thereto.

In this embodiment, the second cavity 455 in which a second light source 480 is disposed can be formed in any positions, e.g. the lateral portion or central portion, of the second light guide element 450. Light emitted from the second light source 480 is directed by the second light guide element 450 and passes through each opening 445 of the first reflecting element 440, such that the corresponding keys, e.g. the key 414, of the key module 100 consist of a second color region. As aforementioned, the disclosed light-emitting module features disposing the light source in the second light guide element, such that a keyboard having different color regions can still be obtained without disposing at least one light source under each opening of the corresponding keys when the number of the corresponding keys consisting of the second color region in the key module 100 increases. The at least one light source can be an LED element.

With the aforementioned light-emitting keyboard possessing various regions of different colors, the users can more accurately press the keys they want in the dark circumstance.

Although specific embodiments have been illustrated and described, it will be obvious to those skilled in the art that various modifications may be made without departing from what is intended to be limited solely by the appended claims.

1. A light-emitting module, comprising:
a first light source;
a first light guide element having a first cavity in which the first light source is disposed;
a first reflecting element having at least one opening, wherein the first reflecting element is disposed under the first light guide element; and
a second light source disposed under the first reflecting element, wherein light emitted from the second light source passes through the opening.

2. The light-emitting module of claim 1, further comprising:
a second light guide element having a second cavity in which the second light source is disposed.

3. The light-emitting module of claim 1, further comprising:
a second reflecting element under the second light source.

4. The light-emitting module of claim 1, further comprising:
a light-shielding element above the first light guide element, wherein the light-shielding element has a predetermined pattern for reduction of light scattering.

5. The light-emitting module of claim 1, wherein the second light source is under the opening of the first reflecting element.

6. The light-emitting module of claim 1, wherein the first light source and the second light source emit light in different colors.

7. The light-emitting module of claim 1, wherein the first light source and the second light source are light-emitting diode and emit light in different colors.

8. The light-emitting module of claim 1, further comprising:
a third light source under the first reflecting element, wherein the first, second and third light sources emit light in different colors.

9. The light-emitting module of claim 1, wherein the opening of the first reflecting element is rectangular, circular or T-shaped.

10. A keyboard, comprising:
a key module; and
a light-emitting module under the key module, comprising:
a first light source;
a first light guide element having a first cavity in which the first light source is disposed;
a first reflecting element having at least one opening, the first reflecting element being disposed under the first light guide element; and
a second light source disposed under the first reflecting element, wherein light emitted from the second light source passes through the opening;
wherein the first light source and the second light source emit light in different colors, resulting in that the key module possesses various regions of different colors.

11. The keyboard of claim 10, further comprising:
a second light guide element, under the first reflecting element, having a second cavity in which the second light source is disposed.

12. The keyboard of claim 10, further comprising:
a second reflecting element under the second light source.

13. The keyboard of claim 10, further comprising:
a light-shielding element above the first light guide element, wherein the light-shielding element has a predetermined pattern for reduction of light scattering.

14. The keyboard of claim 10, wherein the second light source is under the opening of the first reflecting element.

15. The keyboard of claim 10, further comprising:
a third light source under the first reflecting element, wherein the first, second and third light sources emit light in different colors.

16. The keyboard of claim 10, wherein the first light source and the second light source are light-emitting diode.
